(19) United States
(12) Patent Application Publication
(10) Pub. No.: US 2003/0172014 A1
(43) Pub. Date: Sep. 11, 2003

(54) System and method for online valuation and analysis

(76) Inventors: Chris Quackenbush, New York, NY (US); G. William Haas, New York, NY (US); Derek Szot, New York, NY (US); Brian Pietrewicz, Hoboken, NJ (US); William Pappas, New York, NY (US)

Correspondence Address: Kevin R. Spivak, Morrison & Foerster LLP, Suite 5500, 2000 Pennsylvania Avenue, N.W., Washington, DC, 20006-1888, US

(21) Appl. No.: 09/942,954

(22) Filed: Aug. 31, 2001

Related U.S. Application Data
(60) Provisional application No. 60/229,292, filed on Sep. 1, 2000.

(51) Int. Cl. G06F 17/60

(52) U.S. Cl. 705/35

(57) ABSTRACT

The invention provides an online valuation system and method, which provides an user with analytic tools used for valuing a company. The system includes a web server providing online access to a user performing valuation, an internal financial database which retrieves financial data and assumptions from external databases, an analytical tool which retrieves the data from the internal financial database and process the data based on the assumptions. The user may choose an analytic tool suitable for his or her valuation, and the system provides the user with a real time answer. The system updates the financial data and assumptions it keeps at least once a day.

### CLAIM TO PRIORITY

This application claims priority to U.S. Provisional Application Ser. No. 60/229,292 filed Sep. 1, 2000, which is incorporated herein in its entirety.

### FIELD OF THE INVENTION

This invention relates generally to data processing systems and, more specifically, to systems and methods for performing online valuation and analysis of a company.

### BACKGROUND OF THE INVENTION

Traditionally, investment bankers provide corporate clients with information regarding the value of a company and strategic advice regarding ways to increase that value. For example, an investment banker may utilize several valuation methods in order to converge on a range of values for a particular company.

A typical valuation process includes analysis of one or more of the following: (1) Projected Cash Flows derived from Wall Street estimates or internal budgets creating an earnings stream which is used to calculate Internal Rate of Return (IRR), Return on Investment (ROI), discounted for present value, or to derive a specific value relating to a particular industry. For planning purposes, this analysis can be helpful in determining alternative ways to use capital, including, for example, an IPO, or secondary or private placement, or an issuance of a debt instrument to enhance the value of a company are explored. This analysis may further include analysis of the results of a company buying back its stock, buying the stock of other companies, or restructuring the balance sheet, i.e., disposition of assets. (2) Capacity to Achieve a Merger or Acquisition. In this analysis, financial assumptions, accounting rules, and relevant legal provisions are analyzed to predict the results of a business combination. This process helps determine whether a company has a better chance of creating value internally or externally. (3) Peer Comparisons. In this analysis, information about comparable, or peer companies from various sources including, for example, public filings, company reports, regulatory filings, and press releases is analyzed in several different forms.

Currently an investment bank employs a team of analysts and associates who spend hundreds of hours modeling various strategic scenarios, running sophisticated analytic tools, and preparing reports. Much of the analysis and modeling requires input of relevant information, such as, recent financials and assumptions, into existing templates. Sensitivity analyses may be run on the template inputs to produce a range of results. For example, the same model may be run repetitively, with varying values of inputs and assumptions, to achieve different results. The results are evaluated in combination with industry standard statistics and marketing materials. Suggested courses of action, consistent with the results, are then presented to the client, who makes business strategy decisions according to the results.

This process is extremely labor intensive, time-consuming, and repetitive. Investment bankers are typically paid only if a transaction is consummated, regardless of the amount of analysis or hours logged. Therefore, their fees are extremely high, to compensate for their unpaid time spent. The cost of obtaining investment banking services may therefore limit the scope of analysis performed by a company during a valuation, and may even be prohibitive.

Accordingly, a need exists for a more efficient manner of valuing a company, including collecting the appropriate data, running analytic tools, and modeling business scenarios.

### SUMMARY OF THE INVENTION

This invention provides an online valuation system and method, which provides the end-user with analytic tools that may be used to value a company. The system provides real-time answers to a variety of corporate finance questions, in the form of corporate finance and investment banking analytic tools. The system receives input from a user indicating a type of valuation analysis to perform. For example, a user can value a merger of two companies, a buyer and a target. The system further receives, from both the user and its internal or external network accessible databases or data feeds, information reflecting a financial condition of the buyer and target companies. The system filters the received information by, for example, comparing user inputs and assumptions with information received from the data stores and flagging values that appear to be inconsistent. A user may change the value of the inputs and assumptions as desired. The system creates and runs, using the filtered inputs, a model of the merger.

The system provides formatted results and strategic suggestions reflecting both general industry trends and specific financial data of a company. The suggestions guide a user's analysis such that the input values and assumptions will yield realistic output and results, maximize the value of a deal and utilize realistic company and industry information. The system also provides suggestions indicating which of the analytic tools is most applicable for a particular inquiry, business strategy, or scenario. The suggestions may also alert a user to missing values, and if possible compute the missing values by performing an appropriate computation. For example, if a user wishes to buy a company at 25% over its current stock price and current deals have actually been done at 32% over the stock price, the system will inform the user accordingly. Similarly, if 900 out of 1,000 people assign a growth rate of 10% to a particular company's growth rate, the system may suggest an optional growth rate of 10% to the 100 people using other growth rates. Additionally, the system can also suggest additional target companies that the user may be interested in analyzing, based on the current market environment and the buyer's profile.

As the system receives automatic updates from, for example, data feeds of information, it automatically re-computes the displayed values. The model and associated results may be saved for later retrieval. Multiple users may access the system concurrently.

The system also includes an e-mail feature that notifies a user of changes in a company's financial situation. For example, if a company included in a user's target list experiences a significant decrease in its stock price, the system will notify the user of the price change and update the user's previously computed results for that company. The system does this based on monitoring certain key triggers, such as, stock price movement greater than a set parameter, unexpected quarterly numbers, legal rulings, etc.

### BRIEF DESCRIPTION OF THE DRAWINGS

FIG. 1 shows an embodiment of the invention in which a client gains an access to a server of the invention through a network.

FIGS. 2A-2D shows at A a system flow diagram for capacity to pay analysis and detailed merger and acquisition analysis, at B a system flow diagram for projected earnings analysis, at C a system flow diagram for comparable group analysis, and at D a system flow diagram for mapping analysis.

FIGS. 3A and 3B show details on the financial data and assumptions to be used and their exemplary values.

### DETAILED DESCRIPTION OF THE INVENTION

This invention enables delivery to an end user of interactive analytic tools, i.e., analytics, that can be used to answer corporate finance questions in real-time, nearly instantaneously. The analytics are analysis tools that model a particular financial/corporate situation, perform a variety computations, and present results to a user such that the user is guided through the analysis process. The analytic tools also provided the user with suggestions, for example, to maximize the value of a corporate deal, or to implement a more realistic analysis process, and additional information about the situation and relevant company or companies being modeled. A user may use the system to, for example, determine the value of a company, or a potential corporate combination, and in real-time, perform online a variety of analyses associated with a particular business strategy, such as a strategy to merge with, or acquire, another company.

The system stores in databases that it maintains financial data, default values, and assumptions for numerous companies and industries. The system may also retrieve input and assumption data from external data stores or data feeds of information. A user initiates execution of a particular model, which, in turn performs computations according to either user input or default values or assumptions. The term “assumption” refers to modeling and system parameters that drive the analytic tools. The computed results can be stored for later retrieval. The models can be automatically updated on a real-time basis as company numbers and stock prices change. For example, earnings estimates are updated at least once a day from a data feed provided from an outside vendor, such as IBES International Inc. The models can also be updated regularly according to input reflecting industry trends and market knowledge of experts in the investment banking industry. As data changes, the system automatically re-computes and displays the re-computed values.

A user may access the system and its analytic tools by subscribing to a service for a specified period of time or, alternatively, on a per transaction basis. The tools provided by the system can include: a projected earnings analysis, balance sheet restructuring, interest rate, sensitivity analysis, a capacity to pay analysis, a detailed merger and acquisition analysis, a comparable group analysis, illustrative maps, market share studies, market data analysis, discounted cash flow analysis, component parts valuation analysis, leveraged buyout analysis, enterprise value analysis, and imputed valuation. A user may use some or all of these components to satisfy an inquiry, or gain financial insight into a particular situation.

(1) Projected earnings analysis. The projected earnings analysis assists corporate development personnel to budget their financial performance and future earnings. It uses financial information about a company, including, for example, balance sheet, income statement, and other information that is available from public data stores or data feeds to determine financial performance. Users may store several permutations of the results, with the option of printing, emailing, or faxing them. The assumptions used to predict financial performance may include growth rate on revenues or assets, margin, fees collected, fixed and variable expenses, tax rate, dividend percentage, balance sheet leverage, and stock buyback policy. The system provides financial performance information by computing, for example, return on equity, internal rate of return (IRR), net present value, EPS, stock price, price-to-earnings ratio, and capital ratios. The results are displayed to the user in, for example, graphical, tabular, or report format. The results can also be viewed relative to a base case scenario.

(2) Capacity to pay analysis. The capacity to pay analysis is used to determine an optimal purchase of a company, or a corporate combination, given specific conditions, such as a price resulting in zero earnings dilution or a defined market premium. Based on a user-specified, or suggested list of potential targets (or potential acquirers or potential competitors), and user-provided (or default) assumptions and other inputs, an optimal purchase price is computed. Assumptions included in the analysis may include, for example, purchase price, accounting treatment, cost savings, buyer/target company stock price, and buyer/target company projected earnings. Further details on the capacity to pay analysis are provided below.

(3) Detailed merger and acquisition analysis. The detailed merger and acquisition analysis extends the capacity to pay analysis by considering additional data in the analytical process and computing additional values. For example, the following additional data may be considered in this analysis: other forms of consideration (sub-debt, preferred stock, trust preferred, etc.), detailed mark-to-market analysis, itemized detail of merger related charges, schedule of tax-deductibility of such charges, non-interest income break-out, expense break-out, adjustment to provision levels, cash-earnings analysis, ability to perform stock repurchases and alter dividend pay out ratios, discounted cash flows, IRR, and a detailed schedule of shares outstanding to include ESOP Shares and options. The detailed merger model provides various drill-down pages which allow the user to edit many of the calculations. In addition, the merger analysis and the capacity to pay analysis are kept current with accounting and legal regulations.

(4) Comparable group analysis. This analysis compares the financial metrics, performance ratios and market data of a user-selected base company to those of one or more “comparable groups.” Though they can be specifically tailored by the user to suit individual goals of a particular analysis, comparable groups, in a default case, when compared to a base company, allow the user to view the base company's relative performance versus that of the comparable group.

The companies in a comparable group are selected according to parameters, which are dependent on the type of group used. A comparable group can be generated automatically by the analytic tool or created by the user. The companies included in a suggested regional group, which is designed to be representative of the base company's competition, may be selected according to the following parameters: each company should 1) be in the same industry as the base company, 2) be in the same geographic region as the base company and 3) have a total asset figure close to that of the base company. The companies included in a suggested highly valued group, which is designed to be representative of the top companies in the industry, may be selected according to the following parameters: each company should 1) be in the same industry as the base company, 2) have a total asset figure close to that of the base company and 3) meet certain minimum criteria for high performance and high market valuation. Each automatically generated group includes as many companies as possible that meet the particular criteria involved, and certain parameters may adjust according to the industry the companies belong to. Other automatically generated comparable groups may includes companies that represent a certain geographic or industry-wide benchmark, while custom comparable groups can be generated following parameters defined by the user.

The median values of each group's financial metrics, performance ratios and market data are calculated and then compared, in a tabular and graphical format, to those of the base company. These items may include total assets, equity/assets, return on equity, margin, costs/revenues, price/earnings, price/tangible book value, market capitalization, dividend yield, insider ownership and institutional ownership. Though the particular items compared may depend on the industry, they represent those salient and key items used by the particular industry's experts to track a company's financial and market performance. This analysis may be helpful in determining, among other things, the base company's relative financial and market performance versus the selected comparable groups, the particular metrics that the base company outperforms or underperforms the comparable groups and historical financial and market trends particular to an industry.

(5) Mapping analysis. This analysis provides an illustration of individual and pro forma geographic locations of a company. This may be used, for example, to illustrate economies of scale that may be realized when a company buys a competitor or complementary company in close proximity, and closes some of its locations to realize cost savings. For example, for banks, the analytic tool uses FDIC data indicating all FDIC insured bank branches in the United States. The data includes total deposits, growth rate on deposits, addresses as well as latitude and longitude points. This data is fed into a mapping tool, such as Map Quest, ARCIMS, geographical software developed by ESRI, Inc., which outputs a geographic depiction of all of the branches listed by the data. The process is repeated for companies in other industries. Geographic data from either user inputs or network accessible data stores is fed into a conventional mapping tool as described above.

A user may select one or more companies to be plotted on a map using various geographic, corporate, financial and ownership parameters and filters. The map, which offers navigation functionality to the user such as the ability to zoom in or out to an appropriate level and move the view horizontally and vertically, automatically re-centers and zooms to a level that encompasses all of the branches of the companies chosen but provides the most detail possible. If more than one company is plotted, the user has the option of viewing those companies he chooses. One company's branches are differentiated from another's by different map symbols. State, county and city names, highway and street networks and names, and county borders can be viewed if the user chooses. Depending on the zoom level, various types of demographic and census data pertinent to the industry being analyzed can be visually layered over the plotted branches. For example, certain data layers or demographic information such as median household income, population density or urbanized areas may be important to an acquiring institution when profiling a potential target company's market and customer base.

For each company plotted, the user may initiate an automatic search that returns a list of companies that are geographic competitors to the company selected. The software enacts a proximity search for the selected company's branches, selecting those companies with branch locations any of which are within a user-defined distance from any of the selected company's branches. The result set of this automatic search is presented as a list to the user, who selects the desired companies from the set, and then plots the selected companies on the map, along with the initially chosen company already plotted. This feature increases the analysis' efficiency and accuracy by cutting down the time spent on and errors arising from searching for competitors and plotting their branch locations by more traditional methods.

The user has the ability to tailor a custom view best suited for the analysis desired. The user is presented with the option to select among the states, counties and cities the plotted company or companies have presence in. Upon receiving the user's selections, the map re-centers and zooms to an appropriate level to focus on the selected states, counties or cities. If the user only has one company plotted, the states, counties, and cities presented to the user will be only those the company has presence in. If more than one company is plotted and selected, the states, counties and cities presented to the user will only be those that all of the selected companies have presence in. Using this custom view option, the user can quickly and accurately focus on a particular geographic area of a lone company or overlapping branches of multiple companies.

(6) Market share analysis. This analysis provides the user with the ability to view competitors' presence and percentage share in one or more selected companies' markets. In addition, a user can analyze the strategic practicality of a merger by ascertaining how much respective market share each merger partner has, defining whether any anti-trust regulations would be broken assuming the merger is completed and calculating how much of a divestiture would be required for the merger to receive regulatory approval.

A user may select one or more companies to be plotted on a map using various geographic, corporate, financial and ownership parameters and filters. Upon receiving the chosen companies, the software selects data from the particular markets that the companies have presence in, calculates industry-pertinent market share figures for all companies in the chosen companies' markets, and returns a tabular and graphical result set to the user displaying all of the companies, including the originally selected companies, in the particular markets analyzed. Percentage market share and other metrics for measuring market share and presence are specific to the industry, and thus, may differ by industry. This analysis is particularly useful for searching for viewing market competitors of a particular company, finding potential strategic partners and analyzing the potential strategic impact, from a market share perspective, of a merger.

The market share analysis also, upon user input of merging companies, displays whether industry-specific anti-trust regulations have been breached, and, if so, calculates possible alternative business combinations that would maintain the legality of the merger. For instance, if the user inputs two companies, the software will determine their respective market shares, calculate how much combined market share they would have as a merger company, compares this pro forma market share level to the particular industry's anti-trust regulation threshold level, then calculates the minimum amount of a divestiture required to keep the merger legal.

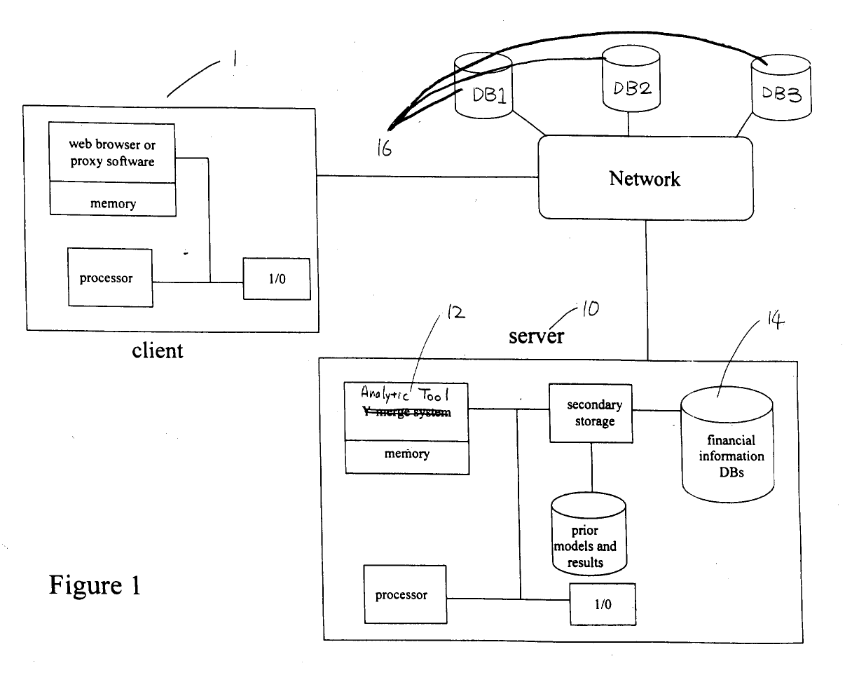

FIG. 1 shows an embodiment of the invention in which a client 1 gains an access to a web server 10 of the invention through a network. The client 1 includes a web browser or proxy software which allows the user to access the system. The client may correspond to, for example, a user's computer running a Microsoft Windows™ operating system with a proper processor, memory and I/O interface. The web server 10 includes the analytic tool 12 and a storage area, e.g., the internal financial data databases 14 that include financial information of various companies, and other data reflecting default values and assumptions used by the analytic tools, and prior models and their results. The financial data and assumptions are automatically retrieved from external financial databases 16.

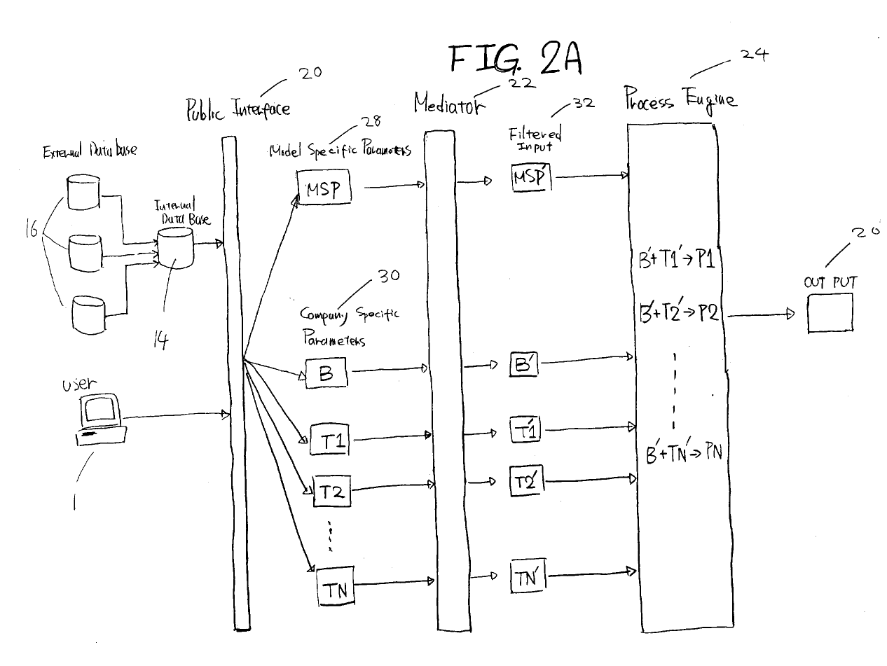

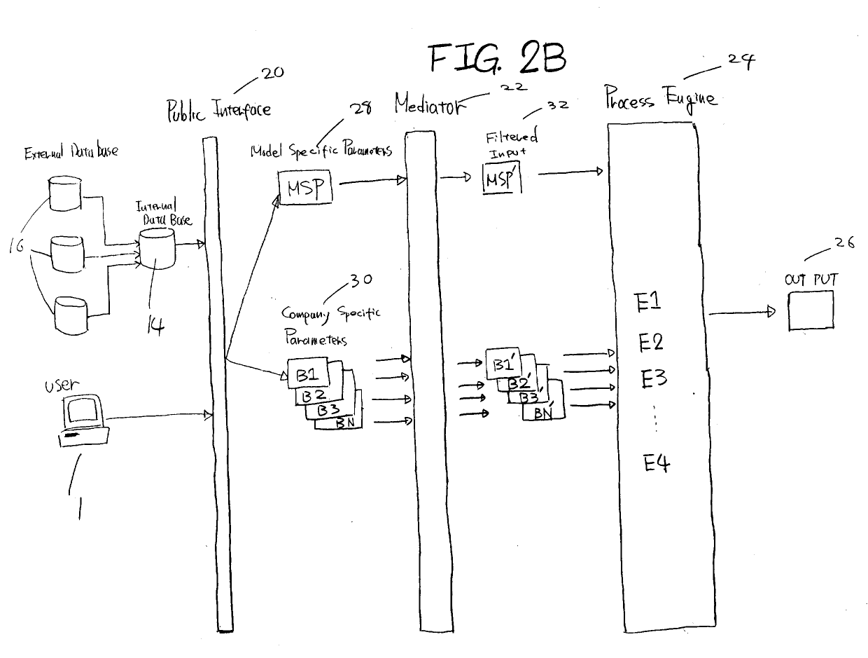

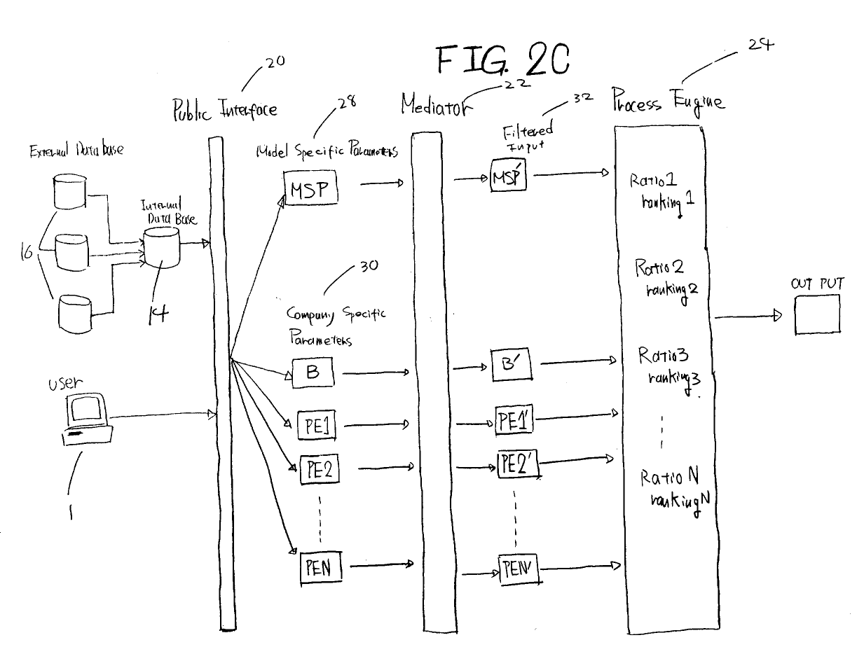

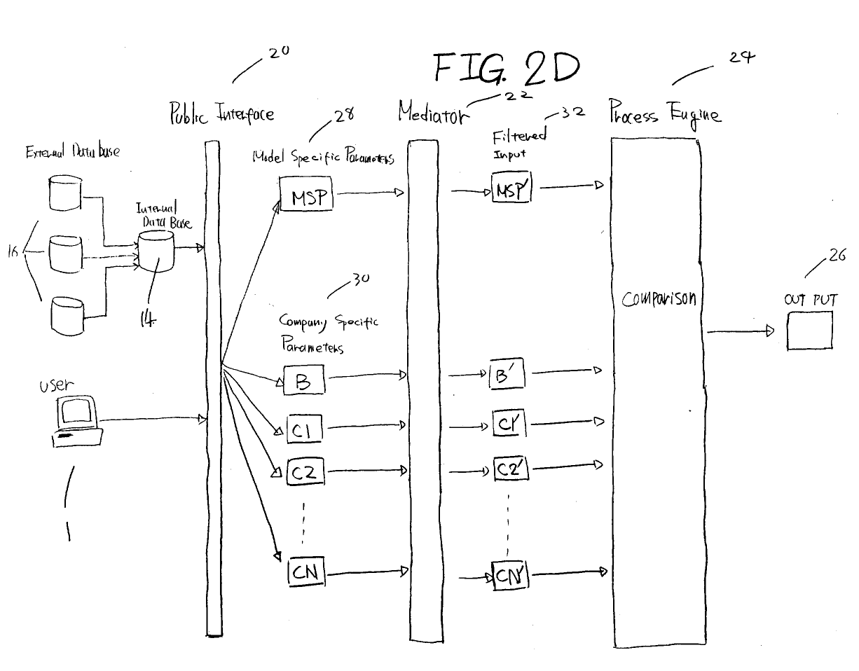

After logging into the system, a user selects which analytic tool to run by, for example, clicking on a designated hypertext link. The graphical user interface then guides the user through the analysis process by prompting the user for the necessary inputs. A user may navigate various screens of the system in a desired order, as appropriate. While navigating the system, a user is generally free to change the financial data and assumptions, whether default or user-specified, as desired. The system automatically performs its computations and provides results. The system also provides suggestions according to both the computed results and the user's input values and assumptions. Much of the data used by the system, such as information derived from live stock feeds, can be automatically updated and the updates can be immediately reflected in the computations performed and results displayed. FIGS. 2A through 2D, outline the process through which each analytic tool operates. Each analysis includes four main components, e.g., public input interface 20, mediator 22, process engine 24, result generation 26. First, the system receives input information, including values and assumptions, either from a user or from various internal or external data stores or data feeds of information. This information may include, for example, a stock price of a buyer or target company, profitability measurements, historical trends, or a cost savings associated with a merger. The inputs may include, for example, financial data of the base company, and/or a second company profile data which includes a variety of data describing the financial situation of the other company or companies, operations profile data that describes the specific routines to be executed, including the financial situation of each company involved.

The system provides default values, or recommended values for each of the financial data and assumptions. The default values may either be derived via statistical analysis or copied from internal financial databases 14 or external databases or data feeds 16, such as SNL Securities, Inc., S&P Comstock Marketguide™, Sheshnoff™, or Stockpoint™. The model automatically uses the default values unless the user overrides the default values by providing override values. A user may input override by values via, for example, a web page(s) included as one or more graphical user interface components, e.g. a combination of text boxes, drop downs, radio buttons, etc. For example, a user may override a default stock price that was retrieved from a network accessible data store by typing in a new value. The user may indicate that certain of the default or override values are to be used globally so that they are shared by, for example, multiple models or multiple companies, as appropriate. The system may also assign default values and assumptions globally so that they apply to multiple companies involved in a framework, or alternatively, to multiple frameworks.

After receiving the input values, the mediation process is implemented by a software program depicted in FIG. 2A-2D as mediator 22. The mediator 22 analyzes the user inputs to develop a set of filtered inputs 32. When performing this analysis, the mediator 22 reviews and checks the integrity of each of the financial data and assumptions. For example, it ensures that the necessary financial data and assumptions have actually been assigned values and that the values fall within an acceptable range. Thus, for example, if the number of diluted shares outstanding for a particular company has not been specified, then the mediator 22 will retrieve the component values necessary to compute the number of diluted shares outstanding, perform the computation, and fill in the computed value. Similarly, if an earnings estimate figure has not been provided, the system may compute an earnings estimate and insert it. Further, the mediator 22 may retrieve missing values and assumptions from indicated locations, i.e., network accessible data stores that include relevant information.

When analyzing the inputs, the mediator 22 may also provide suggestions to change the process framework, or alternatively to make the results more realistic. The suggestions therefore reflect market, industry, or company data that a set of inputs fails to adequately capture. The suggestions may be active or passive. A passive suggestion requires the user to activate a help feature that includes hypertext links to various help pages, definitions, and other explanations about the system and its components. An active suggestion may be in the form of, for example, a pop-up dialog box that is automatically displayed when a user input violates a model's default value ranges.

The mediator 22 outputs the filtered inputs 32, including model specific parameter 28 and company specific data 30, to process engine 24. The process engine 24 uses the filtered inputs to compute results 26 of the process according to the filtered financial data and assumptions.

The results 26 of the process engine 24 are then displayed to the user. The results may be displayed in a variety of formats, including for example, graphs or tables. The system saves the results so that they may be retrieved in the future. A user may change input values and assumptions as desired and the model automatically re-computes the computed values.

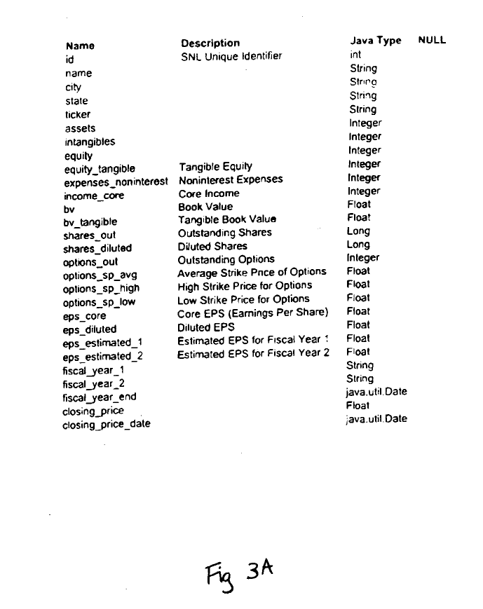

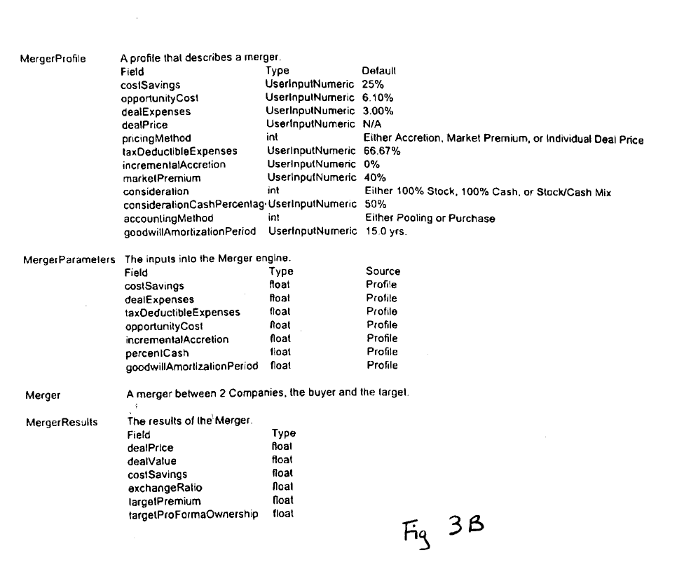

Capacity to pay analysis is described below in detail as an embodiment of this invention. FIG. 2A shows a flow diagram associated the capacity to pay analysis. As is the case with the other analysis, the capacity to pay analysis includes three main component processes, e.g., public input interface 20, mediator 22 and process engine 24. This flow diagram is applicable to a merger between a buyer (base company) B, and one or more target companies T1-TN, or between a target company and one or more buyers. First, the system receives input information, including financial data and assumptions, either from a user 1 or from various internal or external data stores or data feeds of information 14, 16. The input information reflects company specific parameters 30, including buyer profile B and target profile T1-TN, and a profile of the entire merger (model specific parameters 28). The merger specific parameters may include, for example, cost savings, market premium, an earnings estimate of a buyer or target company, or the opportunity cost associated with a merger. The inputs may include, for example, the historical and projected condition of the company participating in the merger, target company profile data, merger profile data that describes the financials of the merger, including the financial situation of each company involved, and a buyer's profile. FIGS. 3A and 3B provide exemplary input information and associated exemplary values. FIG. 3A summarizes the company specific parameters such as company name, location, assets and income, while FIG. 3B summarizes merger specific parameters such as cost savings, deal price and market premium.

The system provides default values, or recommended deal values for each of the inputs and assumptions. The analytic tool automatically uses the default values unless the user overrides the default values by providing override values. A user may input override by values via, for example, a web page(s) included as one or more graphical user interface components, e.g. a combination of text boxes, drop downs, radio buttons, etc. For example, a user may override the percent cash used in a merger that was retrieved from a network accessible data store by typing in a new value. The user may indicate that certain of the default or override values are to be used globally so that they are shared by, for example, multiple merger scenario for multiple companies, as appropriate. The system may also assign default values and assumptions globally so that they apply to multiple companies involved in a merger, or alternatively, to multiple mergers.

After receiving the input values, the mediation process is implemented by the mediator 22. The mediator 22 analyzes the default merger and user inputs to develop a set of filtered inputs 32. When performing this analysis, the mediator 22 reviews and checks the consistency of each of the merger inputs and merger assumptions (MSP, B, T1-TN). For example, it ensures that the necessary financial data and assumptions have actually been assigned values and that the values fall within an acceptable range. Thus, for example, if an earnings estimate for a particular company has not been specified, then the mediator 22 will retrieve the component values necessary to compute an earnings estimate, perform the computation, and fill in the computed value. Similarly, if an intangible amortization figure has not been provided, the system may compute an intangible amortization schedule and insert it. Further, the mediator 22 may retrieve missing values and assumptions from indicated locations, i.e., network accessible data stores that include relevant information.

When analyzing the inputs, the mediator 22 may also provide suggestions to maximize or increase the value of a deal, or alternatively to match the results to prices currently being paid in similar transactions. The suggestions therefore reflect market, industry, or company data that a set of inputs fails to adequately capture. For example, if a user input reflects an undervaluation of a company's deal price, the results may indicate such undervaluation, suggest an alternative price, and indicate its impact on the deal. The suggestions may be active or passive. A passive suggestion requires the user to activate a help feature that includes hypertext links to various help pages, definitions, and other explanations about the system and its components. An active suggestion may be in the form of, for example, a pop-up dialog box that is automatically displayed when a user input violates a model's default value ranges. For example, if a user inputs a deal expense value or one-time charge which is greater than 50% of total deal value, a dialog box will appear and inform the user that the input violates the model's parameters and provide a suggestion indicating an appropriate value, such as the current industry standard.

The mediator 22 outputs the filtered inputs 32, including merger specific parameters MSP′, buyer data B′, and target company data T1′-TN′, to merger engine 24. The merger engine 24 uses the filtered inputs to compute results 26 of the merger according to the filtered values and assumptions. The results are generally computed according to conventional accounting equations conforming to GAAP guidelines.

The results 26 of the merger engine 24 are then displayed to the user 1. The results may be displayed in a variety of formats, including for example, graphs or tables. The system saves the results so that they may be retrieved in the future. The results may also include additional suggestions for maximizing a deal, as described above. A user may change input values and assumptions as desired and the model automatically re-computes the computed values.

The detailed merger and acquisition analysis basically has the same flow diagram as the capacity to pay analysis described above, but works on an expanded data set. When the capacity to pay analysis is successful, the system may suggest the user to perform the detailed merger and acquisition analysis.

FIGS. 2B-2D show below the exemplary flow diagrams. Because the basic system configuration and data flow are similar to the capacity to pay analysis, only the characteristics specific to each analysis are summarized below. The projected earning analysis shown in FIG. 2B is directed to a base company B. The model specific parameters 28 include match earnings and provision method, and the company specific parameters 30 have a plurality of subsets representing respective corporate strategies (B1-BN) of the same base company. These inputs are filtered by the mediator 22 and fed to the processing engine 24, which processes the filtered company specific parameters (B1′-BN′) based on the filtered model specific parameters (MSP′). The earning estimates (E1-EN) based on the different strategies are projected into a predetermined future, for example, 5 years, and compared to each other.

The comparable group analysis shown in FIG. 2C is directed to a base company B and peer companies PE1-PEN. The model specific parameters 28 include peer group generation data and fiscal period (quarterly or annual), and the company specific parameters 30 include base company data B and peer company data PE1-PEN, which may be automatically gathered based on the base company data B by the mediator 22. These inputs are filtered by the mediator 22 and fed to the processing engine 24, which processes the filtered company specific parameters (B′, PE1′-PEN′) based on the filtered model specific parameters (MSP′). The comparisons are made according to several historical ratios (Ratio 1-N), and the companies (B, PE1-PEN) are ranked under respective rations.

The mapping analysis shown in FIG. 2D is directed to a base company B and competitors C1-CN. The model specific parameters 28 include the competitor search criteria and geographic information such as distance from the base company, and the company specific parameters 30 include base company data B and competitor data C1-CN, which may be automatically gathered based on the base company data B by the mediator 22. These inputs are filtered by the mediator 22 and fed to the processing engine 24, which processes the filtered company specific parameters (B′, C1′-CN′) based on the filtered model specific parameters (MSP′). The comparisons are made between the branches of the base company (B) and the branches of each of the competitors (C1-CN). An example: Running the Capacity to Pay Analytic tool

As described above, the capacity to pay analysis determines an optimal purchase price of a company or corporate combination, given specific conditions. The details of running the capacity to pay analysis is described below as an example. First, the user indicates, for example, via a graphical user interface, a base company. The user can view and select from a list of companies by, for example, name, location or size of institution. Once this “base company” is selected, the user indicates whether the base company will be a buyer or target. If the user indicates that the base company is a buyer, the user specifies one or more target companies. The target company or companies may be selected, for example, by searching a database by, for example, name, ticker, asset size and/or geographic location. After building the search criteria the user may add/delete companies to/from the list. The user has the ability to store lists and compare them against each other.

Once the targets have been selected, the user specifies, or affirms system default values and assumptions. The system defaults are monitored and updated regularly by industry experts. These defaults reflect, for example, the average amount of expense savings in an industry, the current multiples being paid, or the current premiums. The user also inputs data reflecting the accounting method to be used in the valuation, the type of consideration to be paid, the amortization period, etc. The assumptions may include, for example, deal consideration, deal pricing, deal accretion, accounting method, amortization period of goodwill, cost savings, buyer's stock price, opportunity cost of cash, effective tax rate, deal expenses, earnings estimates/net income projections, and earnings growth rate. These assumptions are based on current industry trends and/or median statistical data. Once assumptions have been specified or affirmed by the user, the mediation process receives the inputs and assumptions and filters them to create filtered inputs.

The system includes predefined default values and assumptions for each of the values relevant to performing the analysis and computations, including, for example the accounting method and the type of currency. The default values are generally extracted from financial information of a company or particular industry trend data. If the user chooses to override the assumptions, or defaults, the computations are performed according to the user's override values. The system may also make suggestions for certain values, such as the goodwill amortization period or the amount of cost savings.

To filter the inputs, the mediator 22 first verifies the earnings estimates, i.e., earnings per share (EPS). For public companies, the street estimate median is used when it is available. Alternatively, a user may provide an override value.

The mediator 22 then converts EPS data into net income by multiplying the EPS by the diluted shares outstanding. If the street estimate is not available, a growth rate on historical earnings is used to calculate projected net income.

For example, the mediator process may compute the projected EPS as in the following examples in which the data is represented by system parameters:

If profile.projectedEps.override is specified, company.projectedEps=profile.projectedEps.override

Else

IF company.fiscalYear=SNL.fiscalyear1, company.projected Eps=SN.estimated Eps1

Else IF company .fiscalyear==SNL.fiscalYear2, company.projectedEps=SNL.estimateEps2

Else company.projected Eps=SNL.core EPS*company.growthFactor company.effectiveTax Rate=parsed profile.effective Tax Rate

When reconciling the merger parameters and associated user inputs, the mediator may use the following:

params.costSavings=parsed profile cost Savings

params.opportunityCost=parsed profile.opportunityCost

params.dealExpenses=parsed profile.dealExpenses p1 params.taxDeductibleExpenses=parsed profile.taxDeductibleExpenses

params.incrementalAccretion=parsed profile.incrementalAccretion

Cost savings are determined by retrieving a company's historical expense figures and multiplying them by a default percentage that reflects statistical analysis of industry trends, or a specified user override.

The user inputs assumptions on the front-end GUI. Once a user has submitted changes to the default values, the system notes these as overrides. There are two levels of user inputs, general assumptions and detailed assumptions. The general assumptions are global assumptions or default values that apply to all transactions. An accounting method is an exemplary detailed assumption that provides additional detail for a particular transaction. Detailed assumptions may also include, for example, stock price, deal price, deal expenses, cost savings, earnings projections on both a per share and aggregate basis.

Once the filtered inputs have been determined, they are fed into the merger engine 24 which determines pro forma earnings and the pro forma balance sheet. One method for computing the optimal purchase price considers earnings accretion, a comparison of earnings before and after the merger occurs. The computations performed to compute the optimal purchase price are specific to the type of accounting methods used, and the type of currency, e.g., cash or stock, being used to pay for the acquisition. The potential combinations of currency and accounting methods fall into three general categories: (1)100% stock, using purchase accounting, (2)100% cash, using purchase accounting, and (3)cash/stock mix, using purchase accounting, where the user specifies the percentage of each. The associated computations for each of the above combinations of accounting method and consideration used to finance the deal are described further below.

100% Stock, Purchase Accounting. This model either solves for an optimal deal price based on user specified parameters, or uses a user defined deal price. If the deal price is not defined, the model determines a deal price that will meet the specified criteria by using a “solve for” process.

The “solve for” process begins by inserting a deal price based on pre-determined assumptions. This enables the system to calculate dependent results such as aggregate deal value, aggregate deal expenses, opportunity cost, and exchange ratio. The result is then compared to a target result and depending on whether the value is higher or lower, the deal price is adjusted and the process is repeated until a desired level of precision has been achieved.

Deal value is computed as the product of the number of diluted shares acquired and deal price. Aggregate deal value is computed as deal value plus deal expenses. Aggregate deal expense is computed as the product of deal value and a system default percentage, or user override. Opportunity cost, which arises from the cash paid at the closing of the acquisition, is computed as the product of deal expense and the system default percentage or user override. Although 100% stock is the currency exchanged, cash may still be paid for deal expenses (lawyers, bankers, accountants, signage changes, severance policies, etc.). Therefore, a cost is assigned to loss of income that the cash could have earned elsewhere.

Next, the system computes the incremental income attributable to the acquisition by multiplying together and applying taxes to opportunity cost percentage, deal expenses and deal value, and subtracting the result from earnings attributed to the acquisition. For purchase accounting transactions, the goodwill is separated into two components, transactional goodwill and identifiable intangibles. The identifiable intangibles generated in a transaction are amortized over a defined period. The amortization expense is required, under GAAP accounting rules, to be subtracted from net income. To calculate goodwill, adjusted target company tangible equity is subtracted from aggregate deal value. The total goodwill generated is then separated into two components. Identifiable intangibles are calculated by multiplying a default or user-specified premium by the core liabilities of a target company. The total identifiable number is amortized over a defined period, either system default or user-defined.

Next, the exchange ratio is computed by dividing the deal price by the buyer's stock price. The system then computes the number of shares that have been issued to the target company by multiplying the exchange ratio by the number of acquisition diluted shares outstanding. The incremental income attributable per share is computed as added income divided by shares issued to the target. This per share value is compared to the buyer's estimated EPS (calculated by the same methodology as the target company, see above). Incremental accretion to buyer is the percent difference between the incremental EPS attributed to the acquisition and the buyer's estimated EPS. The “solve for” process continues until the percent accretion goal is reached, or until the user specified parameters are met.

If the user indicates a specific deal price, the solve-for process is omitted.

100% Cash Consideration; Purchase Accounting. This analysis solves for a deal price based on either user specified parameters or a user defined deal price. The “solve for” process begins by inserting a deal price based on system defaults. This enables the system to calculate dependent results such as aggregate deal value, aggregate deal expenses, opportunity cost, and exchange ratio, if applicable. The result is then compared to a target result, indicated by the user. Depending on whether the value is higher or lower, the deal price is adjusted and the process is repeated until a desired level of precision has been reached. Deal value is computed as the product of diluted acquisition shares and deal price, and aggregate deal value is computed as deal value plus deal expenses. Aggregate deal expense is computed by multiplying the deal value by the system default percentage or user override. Opportunity cost, which arises from cash paid at the closing of the acquisition, is computed as the product of deal expense and the system default percentage or user override. Since all of the consideration is paid in cash, a cost is assigned to the loss of income that the cash could have earned elsewhere.

Next, the model computes the income attributable to the acquisition by multiplying together and applying taxes to, opportunity cost percentage, deal expenses and deal value, and subtracting from earnings attributed to the acquisition. Goodwill or intangibles are calculated by the same method described previously.

Next, the buyer's accretion to EPS from the acquisition is computed. Accretion to buyer is the percent difference between the EPS attributed to the acquisition and the buyer's estimated EPS and is computed as earnings/income attributable to target added income divided by buyer's diluted shares outstanding. This per share value is compared to the buyer's estimated EPS (calculated by the same methodology as the target company, see above). The “solve for” process is continued until the percent accretion goal is reached, or until the user specified parameters are met.

Cash/Stock Mix; Purchase Accounting. This process is similar to that of the “100% Stock, Purchase Accounting” case, differing only in how the system treats the use of cash.

If the deal price is not defined, the system will begin by searching for a deal price that will meet the specified criteria, the “solve for” process. The “solve for” uses the input (or default) deal price. This enables the system to calculate dependent results such as aggregate deal value, aggregate deal expense, opportunity cost, and exchange ratio, if applicable. The result is compared to a target result, and may be adjusted, which is set by a user either up or down in the “solve for” process depending on whether the result is greater than or less than the “target result.” The program will continue to iterate and loop through the process until a predefined level of precision has been reached.

Deal value is computed as the product of diluted acquisition shares and deal price and aggregate deal value is computed as deal value plus deal expenses. Aggregate deal expense is computed by multiplying deal value by the system default percentage, or user override value. Opportunity cost, which arises from cash paid at the closing of the acquisition, is computed as the product of deal expense and the system default percentage or user override. Since a defined percentage of the consideration is paid in cash and the remainder in stock, a cost must be assigned for loss of income that the cash could have earned elsewhere. Next, the income attributable to the acquisition is computed by multiplying together and tax affecting, opportunity cost percentage, deal expenses and deal value, and subtracting the result from earnings attributed to the acquisitions. Goodwill or intangibles are calculated by the same method described previously.

Next, the exchange ratio, if applicable, is computed as the deal price divided by the buyer's stock price. From the exchange ratio, the number of shares issued to the target company is computed by multiplying the exchange ratio by the number of acquired diluted shares outstanding by the percent of stock issued in the transaction. Incremental income attributable per share is computed as added income divided by the number of shares issued to target. This per share value is compared to the buyer's estimated EPS (calculated by the same methodology as the target company, see above). Incremental accretion to buyer is computed as the percent difference between the incremental EPS attributed to the acquisition and the buyer's estimated EPS. This “solve for” process is continued until the percent accretion goal is reached, or until the user specified parameters are met. If the user specifies a specific deal price, the “solve for” process is not performed.

After the merger engine 24 has completed its computations, the results 26 are displayed. The results 26 of a capacity to pay analysis may include the following data shown with characteristics specific to the data:

Seller Tangible Equity: Get Tangible Equity field from database, if “NA”, then get Equity field.

Buyer Tangible Equity: Get Tangible Equity field from database, if “NA”, then get Equity field.

Seller Current P/E: Get LTMEPS, make sure not negative, if negative “NA”, next take current price divide by LTMEPS.

Goodwill: Aggregate Deal Value−Seller Tangible Equity.

Identifiable Intangibles: Premium*Core Liabilities.

Transactional Goodwill: Goodwill−Identifiable Intangibles.

Premium to Market: Deal Price/Seller Stock Price−1.

Seller % Ownership: Exchange Ratio*Acquisition Diluted Shares/Pro Forma Shares Outstanding.

Deal Value: Seller Acquisition Diluted Shares*Deal Price.

Deal Expenses: Deal Value*Deal Expenses (%) [user input].

Aggregate Deal: Value: Deal Value+Deal Expenses.

Pro Forma Tangible Equity. Buyer Tangible Equity−Goodwill+((Deal Value−Deal Expenses)*(1−Percent Cash)).

Pro Forma Total Assets: Buyer Total Assets+Seller Total Assets+((Deal Value−Deal Expenses)*(1−PercentCash)−Seller Total Equity).

Pro Forma Diluted Shares Outstanding: (Exchange Ratio*Acquisition Diluted Shares*(1−PercentCash))+Buyer Diluted Shares Outstanding.

Pro Form Shares Outstanding (Book): (Exchange Ratio*Acquisition Diluted Shares*(1−PercentCash))+Buyer Actual Shares Outstanding.

Pro Forma Tangible Book Value (TBV): Pro Forma Tangible Equity/Pro Forma Shares Out (Book)*1000.

Buyer Effective Tangible Book Value Accretion: Pro Forma Tangible Book Value/Buyer Tangible Book Value [from database]−1.

Pro Forma Leverage Ratio: Pro Forma Tangible Equity/Pro Forma Total Assets.

Pro Forma EPS: (Added Income from Acquisition+Buyer Equivalent Net income)−Pro Forma Diluted Shares Outstanding*1000.

Buyer EPS Accretion: Pro Forma EPS/Buyer EPS Estimate−1.

Seller EPS Accretion: If PercentCash>0, then “NM”, If Else Pro Forma EPS*Exchange/Seller 2000 EPS Estimate−1.

Seller Tangible Book Value Accretion: If PercentCash>0, then “NM,” If Else, (Pro Forma TBV Exchange)/Seller TBV [from Database]−1.

Seller Dividend Accretion: If PercentCash>0, then “NM” If Else (Buyer Dividend Per Share [from database]*Exchange)/Seller Dividend Per Share [from Database]−1.

The results 26 may be displayed in a variety of formats. Descriptive historical information on target companies, including, for example assets, equity, leverage ratio, ROAE, Current Price, price to earnings ratios, etc. may be displayed with results 26.

Below are exemplary result formats.

(1) Graphic Summary and Result Table

A summary pro forma result set depicting salient charts and ratios which enables the user to quickly determine merger feasibility. This table includes bar charts indicating a maximum price, market premiums and exchange ratio, percent ownership, and deal pricing multiples.

(2) Graph of Exchange Ratio Over Time

Illustrates a buyer's competitive advantage/disadvantage over time. Given the exchange ratio calculated, the graph displays the implied price over a period of time. This graph helps a user to determine if the current price offers the best nominal value for the target company. If the graph indicates a price weakness, the system may, for example, suggest that the target company seek a greater percentage ownership of the pro forma institution to increase the target company's value in the deal.

(4) Buyer Perspective: Key Ratios

A table depicts the impact of a transaction on the buyer. The table displays, for example, exchange ratio, percent ownership, incremental earnings per share accretion, effective earnings per share accretion, tangible book value accretion, and pro forma leverage ratio.

(5) Seller Perspective: Key Ratios

A table illustrates the impact of the transaction on the target company's shareholders. The table displays, for example, exchange ratio, earnings per share accretion to target company, tangible book value accretion to target company, and dividend accretion.

(6) Balance Sheet Reconciliation

Illustrates the mechanics of the merger by depicting the acquisition's impact on the balance sheet. The pro forma results of the current period balance sheet(s) for the buyer and target company, plus or minus acquisition adjustments are displayed.

(7) Income Statement Reconciliation

Reconciles the stand alone projections from the buyer and target company to the pro forma net income, detailing the adjustments (goodwill, cost savings, restructuring impact). It also shows the components, such as, shares outstanding, options outstanding, and deal price, which make up the pro forma diluted shares and the pro forma earnings per share.

(8) Data Tables

Data tables or sensitivity analysis shows how a particular ratio is affected by varying one or more assumptions. Table allows user to specify a range of values and solve for a resulting data set. Such data tables may, for example, be provided for price, cost savings, accretion, cash earnings and projected earnings.

(9) Contribution Analysis

Shows in table and graphic form each company's percentage contribution to the pro forma entity. Generally applicable for 100% stock transactions, the contribution analysis is designed to give the user additional data points for reference. By comparing additional fundamental statistics, this analysis helps the user determine if the amount of stock and ownership being offered is commensurate with what each party brings to the whole. As part of results 26, the system may provide the user with a number of suggestions. For example, if certain merger and acquisition deals are determined to be favorable, the system may direct the user to more detailed analytic tools. For example, if a user has run the capacity to pay analytic tool, the system may suggest that the user execute the detailed merger and acquisition analytic tool to perform additional computations and gain additional insight into a deal. Or as a result of the analysis, if the user appears to be losing money, the system may suggest that the user buy back stock and the system may provide a hypertext link to a strategic partner or an electronic exchange.

While this invention has been described relative to a specific embodiment, one of ordinary skill in the art will appreciate that this system may include additional or different components, while remaining within the scope of the invention.

What is claimed is:

1. A method for valuating and analyzing finances, comprising:
retrieving financial data and assumptions from external databases;
merging the retrieved financial data;
storing the merged financial data in an internal financial database; and
retrieving the financial data and assumptions from the internal financial database.

2. The method of claim 1, further comprising processing the retrieved financial data based on the retrieved assumptions.

3. The method of claim 2, wherein an analytic tool performs the retrieving from the internal financial database and the processing of the retrieved financial data.

4. The method of claim 1, further comprising automatically retrieving the financial data and assumptions from the external databases and updating the financial data and assumptions stored in the internal financial database at least once a day.

5. The method of claim 3, further comprising selecting the analytic tool from a plurality of analytic tools, wherein each of the analytic tools provides analysis.

6. The method of claim 3, further comprising displaying the financial data and assumptions to be processed by the analytic tool to a user such that the user replaces a portion of the financial data and assumptions with data which the user selects.

7. The method of claim 3, further comprising evaluating the financial data and assumptions to be processed by the analytic tool using a predetermined standard of data consistency and issuing a warning to the user when the financial data and assumptions do not meet the predetermined standard.

8. The method of claim 7, further comprising providing alternate financial data or assumptions to improve data consistency.

9. The method of claim 7, further comprising providing an alternate analytic tool to improve data consistency.

10. The method of claim 3, further comprising finding a missing portion of the financial data and assumptions to be processed by the analytic tool, and retrieving data corresponding to the missing portion from the internal financial database or calculating necessary data using data retrieved from the internal financial database.

11. The method of claim 10, further comprising retrieving the data corresponding to the missing portion from the external financial databases when the internal financial database does not maintain the data corresponding to the missing portion.

12. The method of claim 3, further comprising providing an analytic tool different from the analytic tool which has been used when different analysis is needed.

13. The method of claim 1, further comprising providing a result of the financial valuation in a form of a table, a balance sheet or an income statement.

14. The method of claim 3, further comprising storing the financial data and assumptions processed by the analytic tool as a model in an electronic storage for a future use.

15. The method of claim 14, further comprising updating the model by replacing the financial data and assumptions of the model with updated financial data and assumptions retrieved from the internal financial database.

16. The method of claim 15, further comprising sending an e-mail to a user when a change in the updated financial data and assumptions is larger than a predetermined value.

17. The method of claim 5, wherein the selected analytic tool is for a capacity to pay analysis or a detailed merger and acquisition analysis which determines an optimal purchase of a target company for merger by a base company.

18. The method of claim 17, further comprising providing the target company for merger based on the financial data of the base company.

19. The method of claim 5, wherein the selected analytic tool is for a projected earnings analysis which estimates financial performance and future earnings of a company.

20. The method of claim 5, wherein the selected analytic tool is for a comparable group analysis which compares a base company and a target company on financial metrics.

21. The method of claim 20, further comprising providing a group of companies based on the financial metrics of the base company.

22. The method of claim 5, wherein the selected analytic tool is for a mapping analysis which compares branches of a base company and a competitor.

23. The method of claim 5, wherein the selected analytic tool is for a market share analysis which provides market shares of a base company and a target company.

24. The method of claim 23, further comprising providing a warning when a combination of the base company and the target company breaks any anti-trust regulation.

25. The method of claim 3, wherein the financial data and assumptions to be processed by the analytic tool are stock prices, profitability measurements, historical corporate trends, deal considerations, deal pricing, deal accretions, accounting methods, amortization periods of good will, cost savings, opportunity costs of cash, effective tax rates, deal expenses, earnings estimates, net income projections, or earnings growth rates.

26. The method of claim 1, wherein a result of the financial valuation is directed to maximum price, market premiums, exchange ratio, percent ownership, deal pricing multiples, incremental earnings per share accretion, effective earnings per share accretion, tangible book value accretion, pro forma leverage ratio, tangible book value accretion, divided accretion, balance sheet, cash vs. GAAP, or pro forma diluted shares and the pro forma earning per share.

27. A system for providing online corporate financial valuation, comprising:
a server providing an online service to a user requesting a response;
an internal financial database which retrieves and merges financial data and assumptions from external databases; and
an analytic tool which retrieves the financial data and assumptions from the internal financial database and processes the financial data based on the assumptions in response to the request.

28. The system of claim 27, wherein the server is configured such that the user has real time access to the analytic tool and the internal financial databases and real time access to the response provided by the analytic tool.

29. The system of claim 27, wherein the internal financial database updates the financial data and assumptions at least once a day.

30. The system of claim 27, wherein the analytic tool includes a public input interface for receiving the financial data and assumptions to be processed by the analytic tool from the internal financial database and the user, a mediator for assuring consistency of the financial data and assumptions received through the public input interface, and a process engine for performing processing of the assured financial data based on the assured assumptions.

31. The system of claim 27, further comprising a plurality of analytic tools, wherein one of the analytic tools is chosen by the user through the server.

32. The system of claim 30, wherein the mediator displays the financial data and assumptions to be processed by the process engine to the user for replacing a portion of the financial data and assumptions with data which the user selects.

33. The system of claim 30, wherein the mediator evaluates the financial data and assumptions to be processed by the process engine using a predetermined standard of data consistency and issues a warning to the user when the financial data and assumptions do not meet the predetermined standard.

34. The system of claim 30, wherein the mediator finds a missing portion of the financial data and assumptions to be processed by the process engine, and retrieves data corresponding to the missing portion from the internal financial database or calculates necessary data using data retrieved from the internal financial database.

35. The system of claim 30, wherein the process engine processes the financial data and assumptions based on conventional accounting methods.

36. The system of claim 27, wherein the analytic tool stores the financial data and assumptions processed by the analytic tool as a model in an electronic storage, said model being interactively accessed by the user in a subsequent financial valuation.

37. The system of claim 36, wherein the analytic tool updates the model by replacing the financial data and assumptions of the model with updated financial data and assumptions retrieved from the internal financial database.

38. The system of claim 37, wherein the analytic engine sends an e-mail to the user when a change in the updated financial data and assumptions is larger than a predetermined value.

39. The system of claim 27, wherein the financial data and assumptions to be processed by the process engine are stock prices, profitability measurements, historical corporate trends, deal considerations, deal pricing, deal accretion, accounting methods, amortization periods of good will, cost savings, opportunity costs of cash, effective tax rates, deal expenses, earnings estimates, net income projections, or earnings growth rates.

40. The system of claim 27, wherein the response is directed to maximum price, market premiums, exchange ratio, percent ownership, deal pricing multiples, incremental earnings per share accretion, effective earnings per share accretion, tangible book value accretion, pro forma leverage ratio, tangible book value accretion to target company, dividend accretion, balance sheet, cash vs. GAAP, or pro forma diluted shares and the pro forma earnings per share.

41. The system of claim 27, wherein the process engine repeats processing with a variation in a processing parameter in each processing until an output parameter of the processing reaches a predetermined value within a predetermined accuracy.

42. The system of claim 41, wherein the process engine automatically changes the processing parameter in response to the output parameter which is generated in a processing prior to a current processing.

43. The system of claim 41, wherein the processing parameter is a deal price, cost savings, or a net interest spread, and the output parameter is an aggregate deal value, an aggregate deal expense, an opportunity cost, a exchange ratio, an EPS accretion, a seller market premium or an increment for cost savings.

44. A system for providing online corporate financial valuation, comprising:
a server for retrieving data from external databases and for processing the data in response to a request;
a client to issue a request to the server; and
a network to provide connectivity among the server, the external databases and the client.

45. The system of claim 44, wherein the server comprises a web server which provides an online service to the client via the network.

46. The system of claim 45, wherein the server automatically retrieves the data from the external databases without being solicited by the client.

47. The system of claim 46, wherein the server prioritizes the data for the client based on the request or a previous use by the client.
